(19) United States
(12) Patent Application Publication
(10) Pub. No.: US 2025/0131320 A1
(43) Pub. Date: Apr. 24, 2025

(54) SYSTEMS AND METHODS FOR IDENTIFYING SUBSTITUTES USING LEARNING-TO-RANK

(71) Applicant: Walmart Apollo, LLC, Bentonville, AR (US)

(72) Inventors: Priyanshu Chandra, Bangalore (IN); Nikhil Kumar, Bangalore (IN); Romal Rajesh Jaiswal, Amravati (IN); Shubham Jain, Koramangala (IN); Kamiya Motwani, Bangalore (IN); Rahul Ghosh, Bangalore (IN); Kannan Achan, Saratoga, CA (US)

(21) Appl. No.: 18/489,249

(22) Filed: Oct. 18, 2023

(51) Int. Cl. G06N 20/00; G06N 3/0499; G06N 3/08

(52) U.S. Cl. CPC G06N 20/00; G06N 3/0499; G06N 3/08

(57) ABSTRACT

Systems and methods for identifying substitute elements for computer-implemented processes are disclosed. A substitution request identifying an anchor element is received. A set of candidate substitution elements is generated by a trained candidate selection model configured to receive the anchor element, a feature set, and a set of catalog elements. The set of candidate substitution elements is ranked by a trained ranking model configured to receive the anchor element, the feature set, and the set of candidate substitution elements. At least one substitution element is selected from the set of candidate substitution elements and feedback data representative of the suitability of the selected at least one substitution element with respect to the anchor element is received. At least one of the trained candidate selection model or the trained ranking model is updated by applying an iterative training process incorporating at least a portion of the feedback data.

### TECHNICAL FIELD

This application relates generally to machine learning models, and more particularly, to substitution models trained to identify substitute elements.

### BACKGROUND

Substitution systems are configured to identify a suitable replacement element for individual elements that are not available. Substitution of elements may be required in many domains, such as unavailable digital elements (e.g., an interface element unavailable due to an out-of-communication database or server) or unavailable physical elements (e.g., a retail item unavailable due to out-of-stock conditions). When an element is unavailable, a substitution system may examine a catalog of other available items including one or more similar items and select a suitable replacement for the unavailable element (e.g., suitable replacement interface element or content, suitable replacement physical item, etc.).

Some current substitution systems are configured to apply a single approach for selection and ranking of substitute elements. While such systems may be able to identify individually relevant elements, these systems are not capable of identifying candidate substitute elements that are contextually relevant (e.g., cannot identify relative relevance). In addition, these current systems are not capable of identifying substitute elements for target elements having little or no historical information (e.g., cold start problems).

### SUMMARY

In various embodiments, a system including a non-transitory memory and a processor communicatively coupled to the non-transitory memory is disclosed. The processor is configured to read a set of instructions to receive a substitution request identifying an anchor element, and generate, by a trained candidate selection model, a set of candidate substitution elements in response to the substitution request. The trained candidate selection model is configured to receive an input set including the anchor element, a feature set, and a set of catalog elements. The processor is further configured to rank, by a trained ranking model, the set of candidate substitution elements. The trained ranking model is configured to receive an input set including the anchor element, the feature set, and the set of candidate substitution elements. The processor is further configured to select at least one substitution element from the set of candidate substitution elements, receive feedback data representative of a suitability of the selected at least one substitution element with respect to the anchor element, and update at least one of the trained candidate selection model or the trained ranking model by applying an iterative training process incorporating at least a portion of the feedback data.

In various embodiments, a computer-implemented method is disclosed. The computer-implemented method includes steps of receiving a substitution request identifying an anchor element and generating, by a trained candidate selection model, a set of candidate substitution elements in response to the substitution request. The trained candidate selection model is configured to receive an input set including the anchor element, a feature set, and a set of catalog elements. The method further includes a step of ranking, by a trained ranking model, the set of candidate substitution elements. The trained ranking model is configured to receive an input set including the anchor element, the feature set, and the set of candidate substitution elements. The method further includes steps of selecting at least one substitution element from the set of candidate substitution elements, receiving feedback data representative of a suitability of the selected at least one substitution element with respect to the anchor element, and updating at least one of the trained candidate selection model or the trained ranking model by applying an iterative training process incorporating at least a portion of the feedback data.

In various embodiments, a non-transitory computer readable medium having instructions stored thereon is disclosed. The instructions, when executed by at least one processor, cause at least one device to perform operations including training a candidate selection model by applying an iterative training process to modify a classification framework based on a first training data set, training a ranking model by applying an iterative training process to modify a learning-to-rank framework based on the first training data set, receiving a substitution request identifying an anchor element, and generating, by the trained candidate selection model, a set of candidate substitution elements in response to the substitution request. The trained candidate selection model is configured to receive an input set including the anchor element, a feature set, and a set of catalog elements. The device is further configured to perform operations including ranking, by the trained ranking model, the set of candidate substitution elements. The trained ranking model is configured to receive an input set including the anchor element, the feature set, and the set of candidate substitution elements. The device is further configured to perform operations including selecting at least one substitution element from the set of candidate substitution elements, receiving feedback data representative of a suitability of the selected at least one substitution element with respect to the anchor element, and updating at least one of the trained candidate selection model or the trained ranking model by applying an iterative training process incorporating at least a portion of the feedback data.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide substitute element identification and interface generation, in accordance with some embodiments;

FIG. 2 illustrates a computer system configured to implement one or more processes, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a substitution-enabled computer-implemented method, in accordance with some embodiments;

FIG. 7 is a process flow illustrating various steps of the substitution-enabled computer-implemented method of FIG. 6, in accordance with some embodiments;

FIG. 8 is a flowchart illustrating an individual and relative relevance aware substitution method, in accordance with some embodiments;

FIG. 9 is a flowchart illustrating a training method for generating a trained machine learning model, in accordance with some embodiments; and

FIG. 10 is a process flow illustrating various steps of the training method of FIG. 9, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for identifying replacement elements, generating interfaces including replacement elements, and/or training machine learning models to identify replacement elements. In various embodiments, a computer-implemented process receives a request for a first element. The computer-implemented process may include any suitable process, such as, for example, an interface generation process, an order fulfillment process, an inventory fulfillment process, etc. The computer-implemented process identifies that the first element is unavailable and identifies a substitute element for the first element. The substitute element is identified by one or more engines, modules, processes, systems, methods, models, etc. configured to select a substitute element that is individually and relatively relevant to the first element. The computer-implemented process continues execution with the substitute element.

In some embodiments, systems, and methods for identifying replacement elements, generating interfaces including replacement elements, and/or training machine learning models to identify replacement elements include one or more trained candidate selection models and/or ranking models. The trained substitution models may include one or more trained frameworks, such as a learning-to-rank framework, a pairwise ranking framework, a listwise ranking framework, etc. In some embodiments, a candidate selection model may be configured to identify candidate elements for substitution and/or a separate ranking model may be configured to rank candidate elements, although it will be appreciated that a single model may be generated including multiple frameworks configured to apply sequential candidate selection and candidate ranking processes. In some embodiments, the use of separate models (e.g., separate frameworks) for candidate identification and candidate ranking allows the trained substitution model to utilize a deeper feature set including non-primary features to differentiate between candidate elements, e.g., provides relative context to the candidate elements.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

In various embodiments, neural networks which are trained (e.g., configured or adapted) to generate candidate element selections and/or candidate rankings, are disclosed. A neural network trained to generate candidate element selections may be referred to as a trained candidate selection model or a trained selection model. A neural network trained to generate candidate element rankings may be referred to as a trained candidate ranking model or a trained ranking model. A trained candidate selection model may be configured to receive a set of input data, such as an anchor element and a catalog of elements

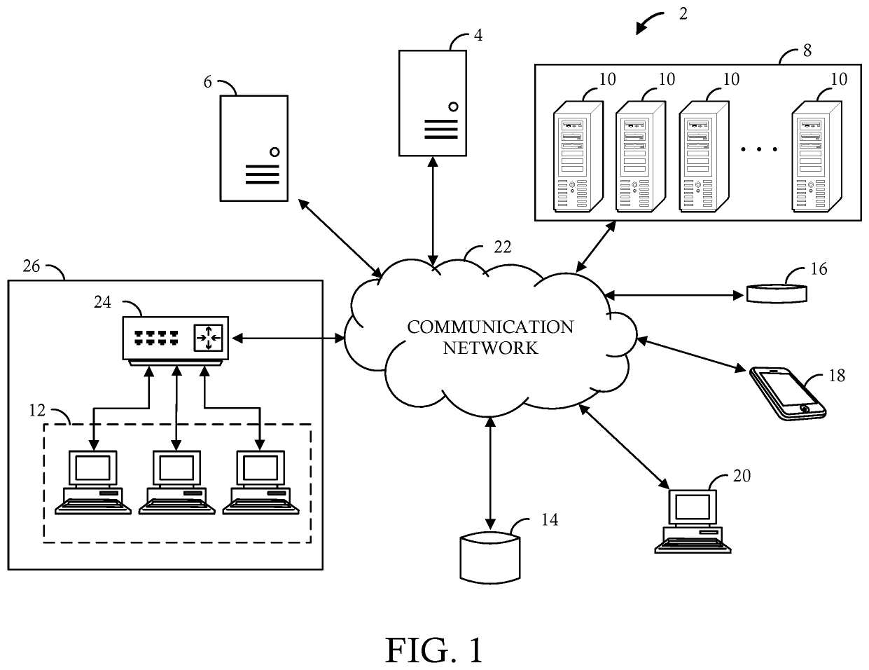

FIG. 1 illustrates a network environment 2 configured to provide execution of computer-implemented processes including substitution of elements, in accordance with some embodiments. The network environment 2 includes a plurality of devices or systems configured to communicate over one or more network channels, illustrated as a network cloud 22. For example, in various embodiments, the network environment 2 may include, but is not limited to, a substitution computing device 4, a web server 6, a cloud-based engine 8 including one or more processing devices 10, workstation(s) 12, a database 14, and/or one or more user computing devices 16, 18, 20 operatively coupled over the network 22. The substitution computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the substitution computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the substitution computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the substitution computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the substitution computing device 4, for example. The workstation(s) 12 may communicate with the substitution computing device 4 over the communication network 22. The workstation(s) 12 may send data to, and receive data from, the substitution computing device 4. For example, the workstation(s) 12 may transmit data related to operations performed at the physical location 26 to substitution computing device 4.

Although FIG. 1 illustrates three user computing devices 16, 18, 20, the network environment 2 may include any number of user computing devices 16, 18, 20. Similarly, the network environment 2 may include any number of the substitution computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the substitution computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first user computing device 16, the second user computing device 18, and the Nth user computing device 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website (such as substitution elements), click on interface elements presented via the website, for example, in the search results, and/or provide input or feedback regarding anchor elements and/or substitution elements via the website. The website may capture these activities as user session data, and transmit the user session data to the substitution computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the substitution computing device 4.

In some embodiments, the substitution computing device 4 may execute one or more models, processes, or algorithms, such as a machine learning model, deep learning model, statistical model, etc., to identify substitute elements for unavailable and/or otherwise unusable elements. The substitution computing device 4 may transmit data identifying and/or related to substitute elements to the web server 6 over the communication network 22, and the web server 6 may display interface elements associated with the substitute elements on the website to the user. For example, the web server 6 may display interface elements associated with and/or incorporating the substitute element to the user on a homepage, a catalog webpage, an item webpage, a window or interface of a chatbot, a search results webpage, or a post-transaction webpage of the website (e.g., as the user browses those respective webpages).

In some embodiments, the web server 6 transmits an element substitution request to the substitution computing device 4. The element substitution request may include a first element identifier (e.g., anchor element identifier) and/or session contextual data related to the computer-implemented process that requested the unavailable first element. The element substitution request may be provided to a substitution engine implemented by the substitution computing device 4. The substitution engine is configured to generate a substitute element identifier, e.g., data identifying and/or related to a selected substitute element, and provide the substitute element identifier to the web server 6. The substitute engine is configured to select a substitute element that is individually and relatively relevant to the computer-implemented process that requested the first element. The web server 6 may integrate the substitute element into the computer-implemented process and continue execution of the computer-implemented process, using the substitute element in place of the first element.

In some embodiments, a user requests a set of item elements from a website hosted by the web server 6. The set of item elements may correspond to inventory items stored in a catalog associated with the website and/or a physical location. The web server 6 may send an inventory check request to determine the availability of each of the item elements (e.g., availability of the underlying inventory item in a physical inventory associated with the website and/or physical location) in the set of item elements to an inventory computing device, such as a processing device 10 and/or a workstation 12. When an element (e.g., an underlying physical element corresponding to an element) is unavailable, the web server 6 transmits a substitution request to the substitution computing device 4. In response to receiving the substitution request, the substitution computing device 4 may execute one or more processes to determine an individually and relatively relevant substitute item and transmit data identifying the selected substitute element to the web server 6 to be displayed to the user.

The substitute computing device 4 is further operable to communicate with the database 14 over the communication network 22. For example, the substitute computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the substitute computing device 4, in some embodiments, the database 14 may be a local storage device, such as a hard drive, a non-volatile memory, or a USB stick. The substitute computing device 4 may store interaction data received from the web server 6 in the database 14. The substitute computing device 4 may also receive from the web server 6 user session data identifying events associated with browsing sessions, and may store the user session data in the database 14.

In some embodiments, the substitute computing device 4 generates training data for a plurality of models (e.g., machine learning models, deep learning models, statistical models, algorithms, etc.) based on substitute feedback data including acceptance rate of substitutions, user-related rankings of substitutions, etc. The substitute computing device 4 and/or one or more of the processing devices 10 may train one or more models based on corresponding training data. The substitute computing device 4 may store the models in a database, such as in the database 14 (e.g., a cloud storage database).

The models, when executed by the substitute computing device 4, allow the substitute computing device 4 to identify individually and relatively relevant substitute items. For example, the substitute computing device 4 may obtain one or more models from the database 14. The substitute computing device 4 may then receive, in real-time from the web server 6, a substitution request including an anchor item identifier and/or session data. In response to receiving the substitution request, the substitute computing device 4 may execute one or more models to identify a substitute item for the anchor item identifier that is individually relevant to the anchor item and additionally relatively relevant to the context of the request, e.g., the session data.

In some embodiments, the substitute computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, substitute computing device 4 may generate a substitute item identifier that is provided to the web server 6 for inclusion in a currently executing computer-implemented process.

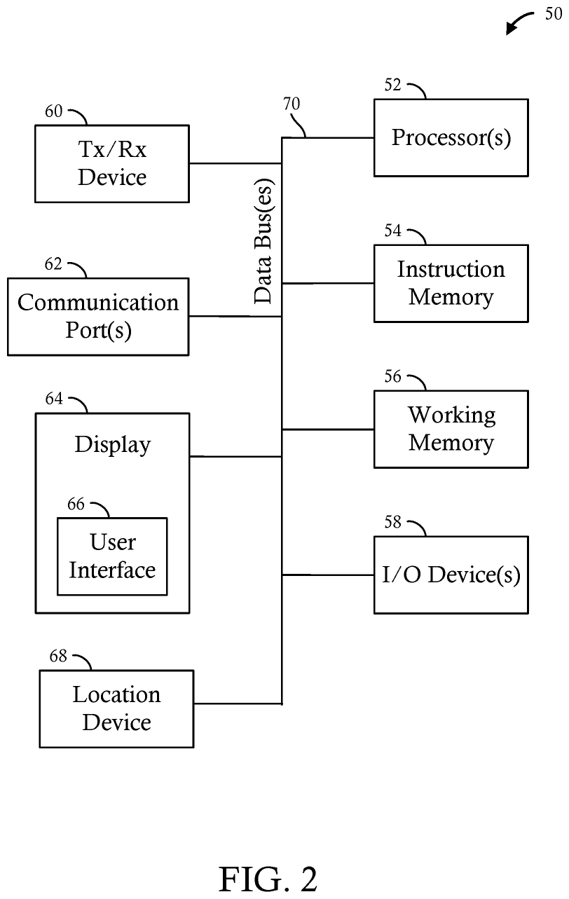

FIG. 2 illustrates a block diagram of a computing device 50, in accordance with some embodiments. In some embodiments, each of the substitute computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for identifying a substitute element for inclusion in a computer-implemented process, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with substitute interface elements and/or an interface for generating a substitution request. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to the a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

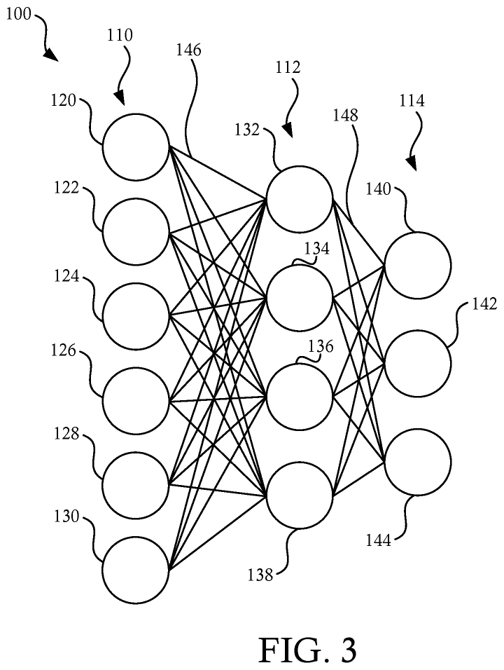

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

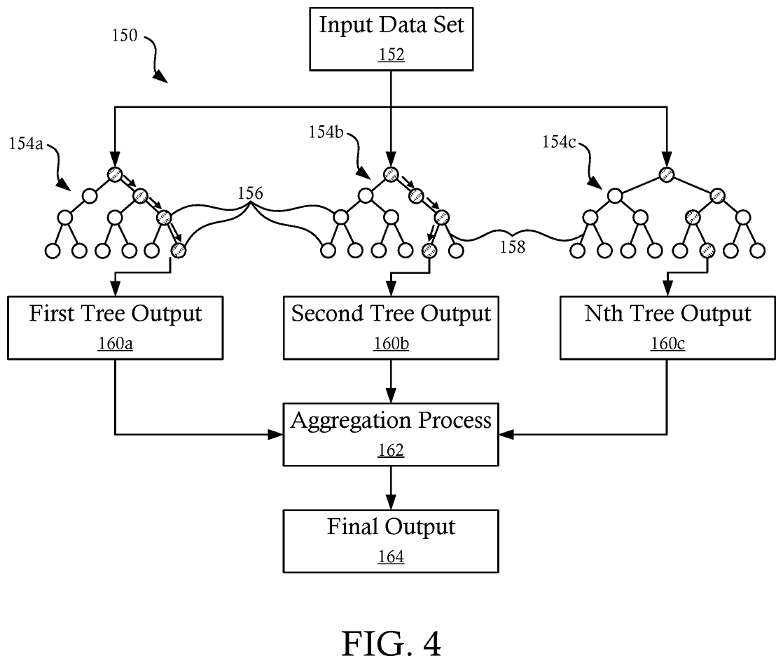

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

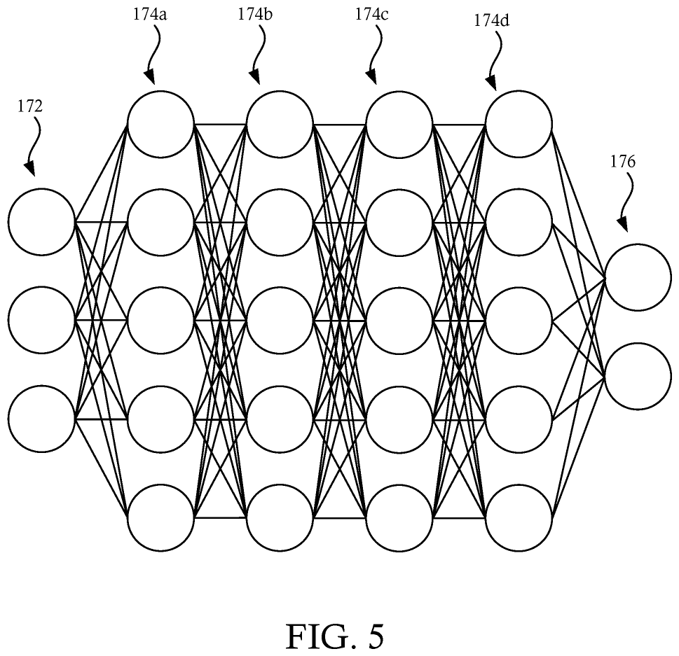

FIG. 5 illustrates a deep neural network (DNN) 170, in accordance with some embodiments. The DNN 170 is an artificial neural network, such as the neural network 100 illustrated in conjunction with FIG. 3, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( i ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each ƒᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

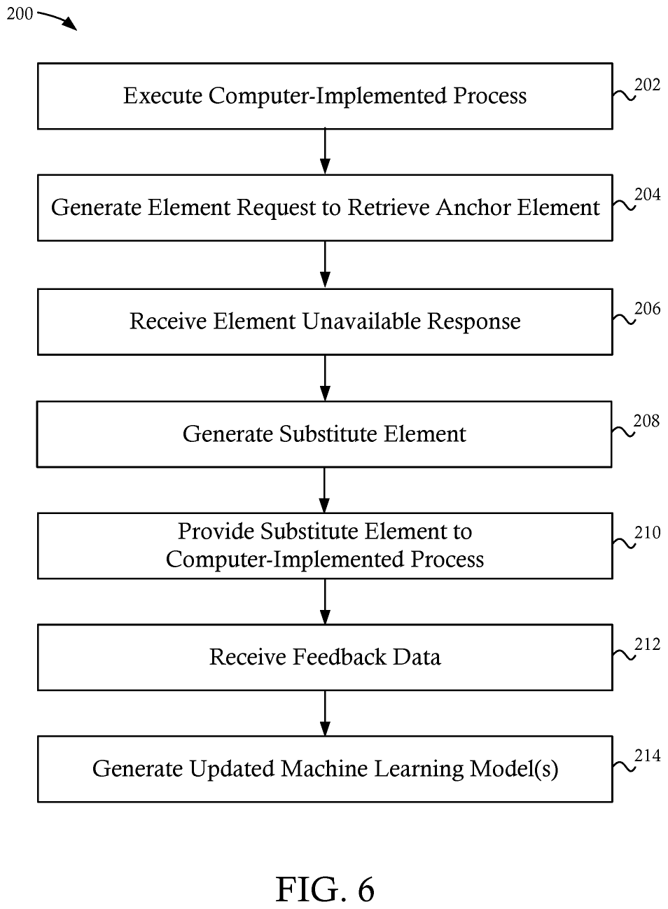

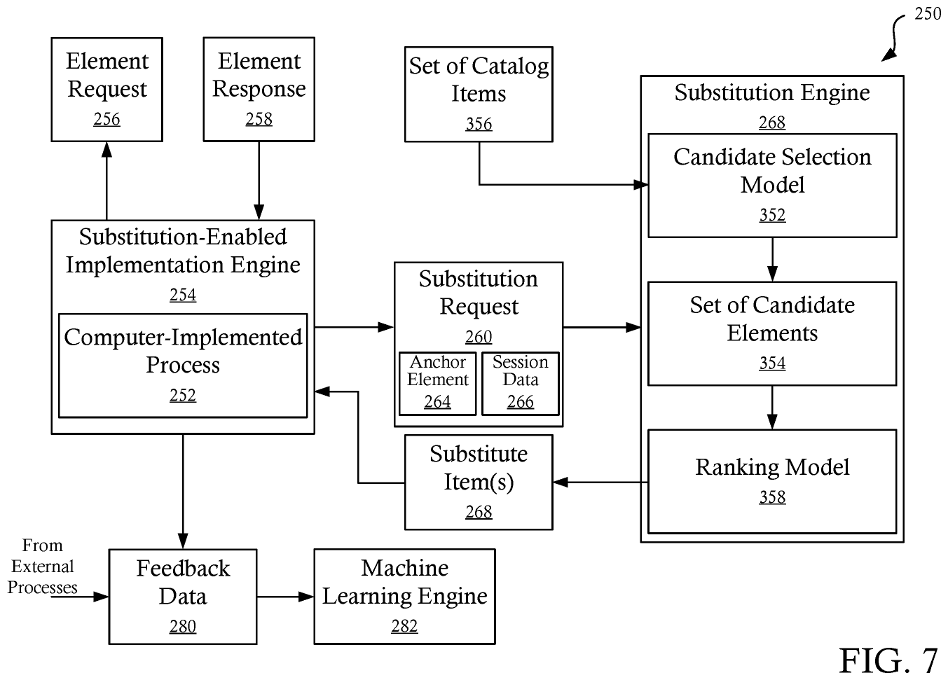

FIG. 6 is a flowchart illustrating a substitution-enabled computer-implemented method 200, in accordance with some embodiments. FIG. 7 is a process flow 250 illustrating various steps of the substitution-enabled computer-implemented method 200 of FIG. 6, in accordance with some embodiments. At step 202, a computer-implemented process 252 is executed. The computer-implemented process 252 may include any suitable process, such as, for example, an interface generation process, an order fulfillment process, an inventory replenishment process, etc. In some embodiments, the computer-implemented process 252 may be implemented by a substitution-enabled implementation engine 254. The computer-implemented process 252 may include any computer-implemented process that is related to retrieval of elements. As one example, a computer-implemented order fulfillment process may be configured to cause at least one item to be obtained from a physical location, the at least one item corresponding to an element, e.g., item data, that is obtained by the computer-implemented order fulfillment process during execution. As another example, in some embodiments, the computer-implemented process may be configured to cause generation of a user interface including at least one element obtained from a remote source, e.g., an interface element obtained from a server during execution of a computer-implemented interface generation process. It will be appreciated that any suitable computer-implemented process that includes retrieval of an element (e.g., digital element, physical element, etc.) may be implemented.

At step 204, the computer-implemented process 252 generates an element request 256 configured to cause a target (e.g., anchor) element to be retrieved. The element request 256 can include a request for a digital element, a request for a physical item, and/or a request for a mixed digital/physical element. For example, in embodiments including a computer-implemented process 252 comprising an order fulfillment process, the element request 256 may include a request to obtain and/or assign an inventory item from a specific inventory, such as an inventory of physical items maintained at a physical location (e.g., a warehouse, store, etc.), to an order. In such embodiments, the element request 256 may include inventory verification to verify that the requested physical item is available at the physical location in sufficient quantities to fulfill the element request 256, a pull request causing the item to be obtained from the inventory location, and/or an update request configured to cause an inventory count of the item to be adjusted in response to the element request 256. As another example, in embodiments including a computer-implemented process 252 comprising an interface generation process, the element request 256 can include a request for an interface element from a remote server. In such embodiments, the element request 256 may include one or more data elements configured to identify the location of the remote server and/or the requested element.

The element request 256 may be transmitted to one or more additional processes and/or may be an internal request generated by the computer-implemented process 252 and/or the substitution-enabled implementation engine 254. In embodiments including additional processes, the element request 256 may be provided to an external (e.g., separate) process and/or engine, such as an inventory retrieval engine, an interface element generation engine, etc. Although embodiments are illustrated with external transmission of the element request 256, it will be appreciated that the element request 256 may be an internal request generated and handled by the computer-implemented process 252.

At step 206, an element unavailable response 258 is received. The element unavailable response 258 indicates that the requested element is not currently available. For example, in embodiments including a computer-implemented process 252 comprising an order fulfillment process, the element unavailable response 258 may include an out-of-stock or item unavailable response indicating that a physical item corresponding to the element request 256 is not available (or not available in sufficient quantities) to fulfill the element request 256. As another example, in embodiments including a computer-implemented process 252 comprising an interface generation process, the element unavailable response 258 may include a time-out or missing element response indicating that the requested server is not available and/or that the requested element is not available. Although specific embodiments are discussed herein, it will be appreciated that the received element unavailable response 258 will be based, at least in part, on the element request 256.

At step 208, a substitute element 268 is obtained (e.g., loaded, received, generated, etc.) In some embodiments, a substitution request 260 is generated and provided to a suitable system, device, module, process, engine, etc., such as, for example, a substitution engine 262. In some embodiments, the substitution request 260 includes an anchor element 264 and/or session data 266. The anchor element 264 includes data configured to identify the target element requested as part of the element request 256. For example, in various embodiments, the anchor element 264 can include an element identification value (e.g. ID number, catalog number, SKU number, etc.) corresponding to the target element and/or an item represented by the target element in a catalog associated with the computer-implemented process 252 and/or the substitution engine 262.

In some embodiments, the session data 266 may include one or more features related to the requested element, the context of the computer-implemented process 252 when the element request 256 was generated, and/or other features related to the anchor element 264 and/or the computer-implemented process 252. For example, in embodiments including items selected from an e-commerce catalog, the session data 266 includes one or more features related to the anchor item, such as, for example, a title embedding of a title of the anchor item, an ingredient feature, a brand feature, a flavor feature, a size feature, a color feature, a dietary attributes feature, a taxonomy, etc. As another example, in some embodiments, the session data 266 may include a current state of the computer-implemented process 252, user features associated with a user executing the computer-implemented process 252, historical features related to prior executions of the computer-implemented process 252, and/or any other suitable features.

It will be appreciated that the features included in the session data 266 and/or utilized by one or more machine learning models (as discussed herein) may be dependent on the context and/or type of element request 256 and/or substitution request 260 generated. For example, in the context of an e-commerce environment, a substitution request 260 may include a requested substitute element from a grocery domain and may utilize grocery inclusive features such as, for example, a title feature, an ingredient feature, a brand feature, a flavor feature, a dietary attributes feature, and a taxonomy feature. As another example in the context of an e-commerce environment, the substitution request 260 may include a requested substitute element from a general merchandise (e.g., apparel, shoes, sporting goods, etc.) domain and may utilize general merchandise inclusive features such as, for example, a title feature, a description feature, a brand feature, a size feature, a color feature, and a taxonomy feature. Although specific embodiments are discussed herein, it will be appreciated that any suitable feature set may be utilized to identify a substitute element in a corresponding domain, category, etc.

In some embodiments, the substitution-enabled implementation engine 254 is configured to receive the element unavailable response 258 and generate the substitution request 260 without interacting with the underlying computer-implemented process 252. For example, in some embodiments, the substitution-enabled implementation engine 254 may be configured to suspend or otherwise pause processing of the computer-implemented process 252 after generation of the element request 256. The substitution-enabled implementation engine 254 may receive the response to the element request 256 and determine if the response is a success response (e.g., includes the requested target element and/or confirmation that the requested target element has been obtained) or an element unavailable response 258 (e.g., a response indicating that the requested element is not available and/or not available in sufficient quantities). When a success response is received, the substitution-enabled implementation engine 254 may continue (or resume) execution of the computer-implemented process 252 and pass the success response to the computer-implemented process 252 for further processing. When an element unavailable response 258 is received, the substitution-enabled implementation engine 254 may maintain the computer-implemented process 252 in a suspended (e.g., paused) state while a substitution request 260 is generated. As discussed in greater detail below, in some embodiments, the substitution-enabled implementation engine 254 may resume execution of the computer-implemented process 252 when a response to the substitution request 260 is received.

In some embodiments, the substitution engine 262 is configured to implement an individual and relative relevance aware substitution method to select a substitute element 268 having a high individual relevance and relative relevance with respect to the anchor element 264 and/or the session data 266. In some embodiments, the substitute element 268 includes an element that may be substituted for the anchor element 264 and will be accepted as a replacement in the context of the computer-implement process 252 (e.g., in the context of the session data 266).

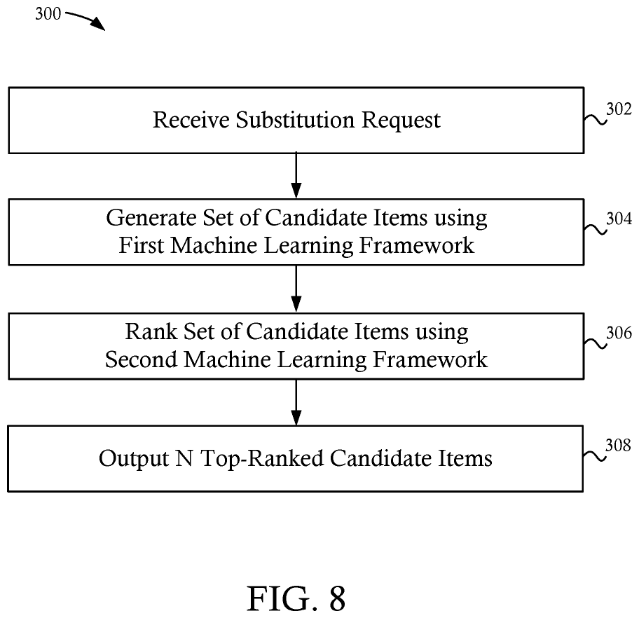

FIG. 8 is a flowchart illustrating an individual and relative relevance aware substitution method 300, in accordance with some embodiments, which is described in conjunction with FIGS. 6-8. At optional step 302, a substitution request, such as a substitution request 260, is received. The substitution request 260 may include an anchor element 264 and/or session data 266. The substitution request 260 may be received by any suitable system, device, engine, module, etc., such as, for example, a substitution engine 262. The substitution engine 262 and the substitution-enabled implementation engine 254 may include separate, distinct engines and/or may be incorporated into a single engine. The anchor element 264 may include the requested target element and/or data identifying the requested target element.

At step 304, a set of candidate elements 354 is generated. The set of candidate elements 354 may be generated by any suitable process, model, module, etc., such as, for example, a candidate selection model 352. The candidate selection model 352 is configured to receive an anchor element 264 and a set of catalog elements 356 and output a set of candidate elements 354. In some embodiments, the set of candidate elements 354 includes each element in the set of catalog elements 356 having an individual relevance (e.g., an individual relevance score such as a classification score) equal to or greater than predetermined threshold. The set of catalog elements 356 may be selected from any suitable set of elements. For example, in the context of an e-commerce environment, the set of catalog elements 356 may include a subset of elements available in an item catalog associated with the e-commerce environment.

In some embodiments, the candidate selection model 352 includes a trained machine learning model configured to identify a subset of elements in the set of catalog elements 356, for example, by classifying, clustering, grouping, etc. the set of catalog elements 356 and the anchor element 264. The candidate selection model 352 may include any suitable machine learning framework such as, for example, a trained classification framework, a trained clustering framework, etc. In some embodiments, the candidate selection model 352 includes a trained feed forward neural network framework configured to classify each of the elements in the set of catalog elements 356 and the anchor element 264, although it will be appreciated that any suitable classification framework may be selected. As discussed in greater detail below, a classification framework, such as a feed forward neural network framework, may be trained to generate a trained candidate selection model 352 by applying an iterative training process to adjust one or more hyperparameters of the classification framework. A training dataset for training a candidate selection model 352 may include historical data identifying an anchor element, one or more corresponding substitute elements, and/or features related to the anchor element and corresponding substitute elements. The features included in the training dataset in the context of an e-commerce environment may include, but are not limited to, title, constituent parts (e.g., ingredients, sub-elements, etc.), brand, flavor, size, color, dietary attributes, taxonomy, etc. Although specific embodiments are discussed herein, it will be appreciated that any suitable feature set can be included in a training dataset for training a candidate selection model 352.

At step 306, the set of candidate elements 354 is ranked. The set of candidate elements 354 may be ranked by any suitable system, device, module, engine, process, etc., such as, for example, a ranking model 358. The ranking model 358 is configured to receive the set of candidate elements 354 and one or more additional inputs, such as feature inputs, and rank the set of candidate elements 354 by relative relevance of the candidate elements with respect to the anchor element 264 and/or the context of the substitution request 260 as determined by the session data 266.

In some embodiments, the ranking model 358 includes a trained machine learning model configured to rank the set of candidate elements 354. The ranking model 358 may include any suitable machine learning framework such as, for example, a trained learning-to-rank framework (e.g., a trained learning-to-rank pairwise framework, a trained learning-to-rank listwise framework, etc.). The learning-to-rank framework may include an XGBoost framework and/or a LambdaMART framework, although it will be appreciated that any suitable learning-to-rank framework may be selected. As discussed in greater detail below, a ranking framework, such as a learning-to-rank framework, may be trained to generate a trained ranking model 358 by applying an iterative training process to adjust one or more hyperparameters of the learning-to-rank framework. A training dataset for training a ranking model 358 may include historical data identifying ranked sets of candidate elements, one or more corresponding interactions or feedback related to the ranked set of candidate elements, and/or features related to the ranked sets of candidate elements. The features included in the training dataset in the context of an e-commerce environment may include, but are not limited to, title, constituent parts (e.g., ingredients, sub-elements, etc.), brand, flavor, size, color, dietary attributes, taxonomy, etc. Although specific embodiments are discussed herein, it will be appreciated that any suitable feature set can be included in a training dataset for training a ranking model 358.

In some embodiments, the ranking model 358 is configured to minimize a loss function over one or more candidate elements. For example, in embodiments including a pairwise ranking framework, the acceptance rate of a first candidate substitute element may be compared to an acceptance rate of a second candidate element. A loss function for a pairwise framework may be defined as:

$${ℒ}_{pairwise} = {\sum }_{y ( {d}_{i} ) > y ( {d}_{j} )} max ( 0 , 1 - ( {f}_{θ} ( {d}_{i} ) - {f}_{θ} ( {d}_{j} ) ) )$$

where dᵢ is the i^{th} candidate element and associated input features, dⱼ is the j^{th} candidate element and associated input features, y(d) is the ground truth for a candidate element, and ƒ_{θ} is the model/framework function. A pairwise ranking framework may be configured, for example via an iterative training process, such that a model score Sᵢ generated by the model/framework function ƒ_{θ} for an i^{th} candidate element is greater than a model score Sⱼ generated by the model/framework function ƒ_{θ} for an j^{th} candidate element when an acceptance rate of the i^{th} candidate element is greater than an acceptance rate for the j^{th} candidate element.

As yet another example, in embodiments including a listwise ranking framework, discounted cumulative gain of a selected candidate element may be considered with respect to the set of candidate elements 354. A listwise framework may include an objective function defined as:

$$D C G = {\sum }_{i = 1}^{N} \frac{y ( {d}_{i} )}{{log}_{2} ( rank ( {d}_{i} ) + 1 )}$$

where DCG is the discounted cumulative gain, dᵢ is the i^{th} candidate element and associated input features, d is the ground truth for a candidate element, and rank is the ranking of the candidate element. The objective function is configured to maximize DCG (e.g., based on ranks of candidate elements) over the set of candidate elements 354 to optimize the rankings.

At step 308, one or more of the top-ranked candidate elements in the set of candidate elements 354 is output as a substitute element. For example, in some embodiments, the top-ranked candidate element (as determined by the ranking model 358) is selected as a substitute element 268 for the anchor element 264. As another example, in some embodiments, the top N ranked candidate elements (as determined by the ranking model 358) are selected as a set of substitute elements 268 for the anchor element 264. Each of the set of substitute elements 268 may be provided in response to the substitution request 260 and one or more processes may be applied to select a subset of the substitute elements 268 for use in the computer-implemented process 252.

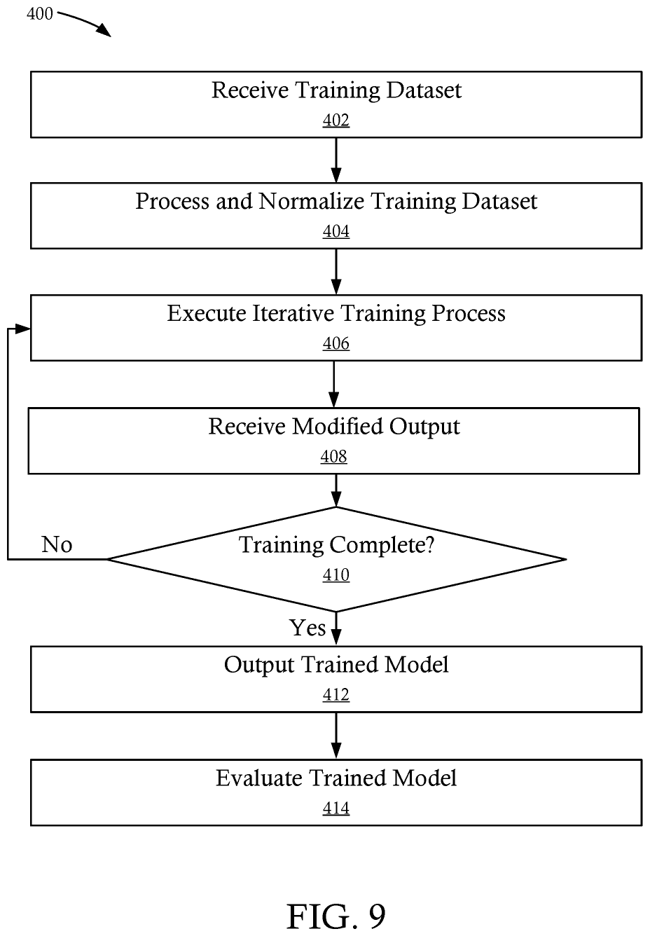

As illustrated in FIG. 9, a separate candidate selection model 352 and ranking model 358 are applied to identify one or more substitute elements 268. The application of a candidate selection model 352 utilizing a first framework, e.g., a classification framework, and a separate ranking model 358 utilizing a second framework, e.g., a learning to rank framework, provides for substitute elements that are selected based on both individual relevance of the substitute element with respect to the anchor element and the relative relevance of the candidate element. Although embodiments are illustrated with separate and distinct models, it will be appreciated that the candidate selection model 352 and the ranking model 358 may be embodied by a single model that includes separate frameworks for candidate selection and ranking.

With reference again to FIGS. 6-7, at step 210, the substitute element 268 is provided to the computer-implemented process 252 in place of the anchor element 264 and execution of the computer-implemented process 252 is continued (e.g., resumed). The computer-implemented process 252 may be resumed with or without an indication that a substitute element 268 has been substituted for the requested anchor item. For example, in some embodiments, the computer-implemented process 252 includes generation of a user interface including the substitute element and an indication that a substitute element has been included.

At step 212, feedback data 280 related to the provided substitute element(s) 268 is received. The feedback data 280 may be provided by the computer-implemented process 252 and/or may be provided by subsequent and/or additional processes. For example, in some embodiments, the computer-implemented process 252 provides feedback data regarding the results of processing utilizing the substitute element 268 in place of the requested anchor element 264. As another example, in some embodiments, feedback data regarding acceptance of the substitute element may be received from an additional process, such as a feedback process. The feedback process may include any suitable process configured to obtain feedback from any suitable system, individual, etc. regarding substitution of the substitute element(s) 268 for the anchor element 264.

At step 214, one or more updated models are generated. For example, in some embodiments, the feedback data 280 is provided to a machine learning engine 282 configured to generate one or more updated, retrained, and/or new machine learning models, such as an updated, retrained, and/or new candidate selection model and/or ranking model. The machine learning engine 282 may be configured to receive additional data, such as, for example, training datasets. In some embodiments, the feedback data 280 is included in and/or used to modify training datasets provided to the machine learning engine 282. For example, an updated training dataset may be generated by modifying (e.g., weighting, updating, etc.) a previously used training dataset to incorporate the feedback data 280. Although certain embodiments are discussed herein, it will be appreciated that the feedback data 280 may be utilized in any suitable fashion by the machine learning engine 282 to generate one or more updated, retrained, and/or new machine learning models.

As one non-limiting example, in some embodiments, the substitution-enabled computer-implemented method 200 may be applied in the context of an e-commerce environment to identify substitute items during an order fulfillment process. In such embodiments, the computer-implemented process 252 may include an order fulfillment process configured to cause fulfillment of an e-commerce order, such as a grocery or general merchandise order. The order fulfillment process may be configured to cause items included in a corresponding order to be obtained at a physical location and prepared for shipment, delivery, pick-up, etc. The order fulfillment process may further include generation of an interface configured to cause the items to be obtained and/or configured to receive feedback data regarding the fulfillment process.

In some embodiments, the order fulfillment process may generate an element request 256 for each item in the order. The element request 256 may include an inventory verification request and/or an inventory assignment request. An inventory verification request may include a request to review inventory data associated with the corresponding physical location to determine if a sufficient quantity of the item (e.g., each item in an order) is available at the physical location to fulfill the order. Similarly, an inventory assignment request may include a request to assign a specific quantity of an item identified in inventory data to the order. The element request 256 may be sent directly to an inventory management system to confirm availability of the item and/or may be sent to a separate process that generates the inventory verification and/or inventory assignment request.

The order fulfillment process may receive an element unavailable response 258 indicating that the inventory data includes an insufficient quantity of the corresponding item to fulfill the order. The element unavailable response 258 may include, but is not limited to, an out-of-stock response and/or an in-stock but insufficient quantity response. The element unavailable response 258 may be received by the order fulfillment process and/or may be received by a substitution-enabled implementation engine 254 configured to implement the order fulfillment process.

A substitution request 260 may be generated requesting a substitute item for the unavailable item, e.g., for an anchor item. The substitution request 260 may be generated directly by the order fulfillment process and/or may be generated by the substitution-enabled implementation engine 254. The substitution request 260 may be provided to a substitution engine 262, such as an item substitution engine, configured to generate one or more substitute items for the unavailable item. The substitution request 260 may include data identifying the anchor element 264 (e.g., the unavailable item) and session data 266 identifying a context of the substitution request 260, such as, for example, a catalog of items available at the physical location (e.g., in-stock inventory information) and associated features of the catalog of items.

The substitution engine 262 may apply a candidate selection model 352 to identify a set of candidate elements 354 that may include suitable substitutes for the out-of-stock anchor element 264. The candidate selection model 352 includes a first trained model framework such as a trained classification framework. The set of candidate elements 354 may include, for example, similar e-commerce items. As one non-limiting example, where the anchor element 264 includes an e-commerce grocery item such as BrandX ProductY ParameterZ, where BrandX identifies the brand of the item, ProductY identifies the type of product, and ParameterZ identifies a variable parameter, candidate items may include, but are not limited to, BrandA ProductY ParameterZ, BrandX ProductB ParameterZ, BrandA ProductB ParameterC, etc. (e.g. suitable substitutes for BrandA Honey Greek Yogurt may include BrandB Honey Greek Yogurt, BrandA Cherry Greek Yogurt, BrandB Blueberry Yogurt, etc.). The candidate selection model 352 may be configured to candidate substitute elements that are individually relevant with respect to the anchor element 264.

The substitution engine 262 may apply a ranking model 358 to rank the set of candidate elements 354. The ranking model 358 includes a second trained model framework, such as a trained learning-to-rank framework including a pairwise and/or listwise ranking. The ranking model 358 may be configured to rank the set of candidate elements 354 to identify candidate elements that are relatively relevant with respect to the anchor element 264 and/or the context of the order. In some embodiments, the ranking model 358 may be configured to receive user features configured to provide user-specific context with respect to the ranking of the set of candidate elements 354.

The substitution engine 262 may output a top-ranked substitute item selected from the set of candidate elements 354 for inclusion in the order in place of the requested anchor element 264. For example, the substitution engine 262 may select a substitute element 268 having a lower individual relevance (e.g., an item that has a lower classification score as generated by the candidate selection model 352) but a higher relative relevance for the order. The substitute item may be provided to the order fulfillment process for inclusion in the order, e.g., the order fulfillment process may cause the substitute item to be obtained in place of the requested anchor item and included in the order.

The below chart illustrates a comparison between substitute elements generated using a traditional substitution system and substitute elements selected using the disclosed substitute-enabled computer-implemented method 200. For an anchor item of BrandX ProductY SizeZ, substitutes are shown in ranked order as generated by the traditional substitution system and the substitute-enabled computer-implemented method 200. The substitutes are shown with corresponding acceptance rates in parentheses:

| | 1st | 2nd | 3rd | 4th | 5th |
|---|---|---|---|---|---|
| Prior Process | Item 1 | Item 2 | Item 3 | Item 4 | Item 5 |
| | (74%) | (72%) | (73%) | (90%) | (88%) |
| Disclosed Process | Item 6 | Item 7 | Item 5 | Item 4 | Item 1 |
| | (97%) | (92%) | (88%) | (90%) | (74%) |

As shown in the above chart, the prior substitution methods generate sets of substitute elements that have lower acceptance rates as compared to the disclosed methods. The disclosed substitute-enabled computer-implemented method 200 identified two substitute elements, e.g., Item 6 and Item 7, having very high acceptance rates that were not identified by the prior substitution methods. In addition, the prior substitution methods rank items having much higher acceptance rates lower while the disclosed substitute-enabled computer-implemented method 200 includes items having higher acceptance rates at a higher rank.

The disclosed substitute-enabled computer-implemented method 200 provides an improved inversion rate and an improved weighted inversion rate as compared to prior systems. For example, in some embodiments, the disclosed systems and methods utilizing a candidate selection model 352 and separate ranking model 358 provide a greater than 10% improvement in inversion and weighted inversion as compared to prior systems utilizing a single framework (e.g., graph convolutional network) for selecting and ranking substitute elements, providing a significant improvement in acceptance of generated substitutes over existing systems.

Identification of suitable substitute elements in the context of an e-commerce environment can be burdensome and time consuming for users, especially if presented substitute options have low acceptance rates or lack relative relevance. Typically, a user may locate information regarding substitute elements or items by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding substitutes for unavailable items.

Systems including a trained candidate selection model and a trained ranking model, as disclosed herein, significantly reduce this problem, allowing users to locate relevant substitute items (e.g., interface elements representative of substitute items) with fewer, or in some case no, active steps. For example, in some embodiments described herein, when a user is presented with relevant substitute items, each interface element includes, or is in the form of, a link to an interface page for providing feedback regarding the selected substitute item. Each recommendation thus serves as a programmatically selected navigational shortcut to an interface page, allowing a user to bypass the navigational structure of the browse tree. Beneficially, programmatically identifying substitute items and presenting a user with navigations shortcuts to these tasks may improve the speed of the user's navigation through an electronic interface, rather than requiring the user to page through multiple other pages in order to locate the substitute item elements via the browse tree or via a search function. This may be particularly beneficial for computing devices with small screens, where fewer interface elements are displayed to a user at a time and thus navigation of larger volumes of data is more difficult.

It will be appreciated that identification of relevant substitute elements as disclosed herein, particularly for large datasets intended to be used in the context of e-commerce environments and/or in the context of order fulfillment processes, is only possible with the aid of computer-assisted machine-learning algorithms and techniques, such as classification models and/or ranking models. In some embodiments, machine learning processes including classification models such as feed forward neural networks and/or ranking models including learning-to-rank networks including pairwise or listwise ranking are used to perform operations that cannot practically be performed by a human, either mentally or with assistance, such as identification of substitute elements that are individually and relatively relevant given the context of a currently executing computer-implemented process. It will be appreciated that a variety of machine learning techniques can be used alone or in combination to generate substitute elements.

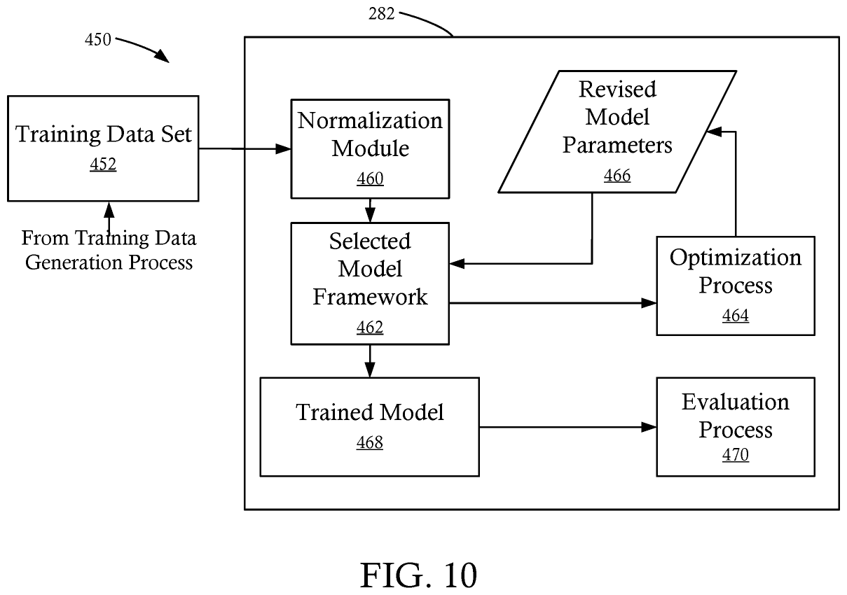

In some embodiments, a substitute engine 262 can include and/or implement one or more trained models, such as a trained candidate selection model and/or a trained ranking model. In some embodiments, one or more trained models can be generated using an iterative training process based on a training dataset. FIG. 9 illustrates a method 400 for generating a trained model, such as a trained optimization model, in accordance with some embodiments. FIG. 10 is a process flow 450 illustrating various steps of the method 400 of generating a trained model, in accordance with some embodiments. At step 402, a training dataset 452 is received by a system, such as a processing device 10. The training dataset 452 can include labeled and/or unlabeled data. For example, in some embodiments, a set of labeled data including anchor elements, corresponding candidate substitute elements for each anchor element, acceptance rate of each corresponding candidate substitute element, and/or features for each of the anchor element and/or candidate substitute elements is provided for use in training a model.

At optional step 404, the received training dataset 452 is processed and/or normalized by a normalization module 460. For example, in some embodiments, the training dataset 452 can be augmented by imputing or estimating missing values of one or more features associated with classification and/or ranking frameworks. In some embodiments, processing of the received training dataset 452 includes outlier detection configured to remove data likely to skew training of a candidate selection model and/or a ranking model. In some embodiments, processing of the received training dataset 452 includes removing features that have limited value with respect to training of an associated model.

At step 406, an iterative training process is executed to train a selected model framework 462. The selected model framework 462 can include an untrained (e.g., base) machine learning model, such as an untrained classification framework (e.g., an untrained feed forward neural network framework), an untrained ranking framework (e.g., an untrained learning-to-rank pairwise framework, an untrained learning-to-rank listwise framework, an untrained XGBoost framework, and untrained LambdaMART framework, etc.), and/or a partially or previously trained model (e.g., a prior version of a trained classification model or a trained ranking model). The training process is configured to iteratively adjust parameters (e.g., hyperparameters) of the selected model framework 462 to minimize a cost value (e.g., an output of a cost function) for the selected model framework 462. In some embodiments, the cost value of a candidate selection model is related to individual relevance of a candidate element with respect to an anchor item and the cost value of a ranking model is related to the relative relevance of a candidate element with respect to an anchor item. As discussed above, a cost value may correspond to a selected framework, such as a loss function for a pairwise ranking framework, a discounted cumulative gain for a listwise ranking framework, etc.

The training process is an iterative process that generates set of revised model parameters 466 during each iteration. The set of revised model parameters 466 can be generated by applying an optimization process 464 to the cost function of the selected model framework 462. The optimization process 464 can be configured to reduce the cost value (e.g., reduce the output of the cost function) at each step by adjusting one or more parameters during each iteration of the training process. As discussed above, a cost value may correspond to a selected framework, such as a loss function for a pairwise ranking framework, a discounted cumulative gain for a listwise ranking framework, etc.

After each iteration of the training process, at step 408, a determination is made whether the training process is complete. The determination at step 408 can be based on any suitable parameters. For example, in some embodiments, a training process can complete after a predetermined number of iterations. As another example, in some embodiments, a training process can complete when it is determined that the cost function of the selected model framework 462 has reached a minimum, such as a local minimum and/or a global minimum.

At step 410, a trained model 468, such as a trained classification model and/or a trained ranking model, is output and provided for use in an individual and relative relevance aware substitution process, such as the substitution-enabled computer-implemented method 200 discussed above with respect to FIGS. 6-7. At optional step 412, a trained model 468 can be evaluated by an evaluation process 470. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

The disclosed systems and methods including training and implementation of machine learning models including a trained classification model and a trained ranking model provide an improvement to operation of a computer system. As one example, implementation of a trained classification model and a trained ranking model, as described in conjunction with the substitute-enabled computer-implemented method 200, provides an improvement in operation of a computer system in response to a requested element being unavailable. The disclosed systems and methods allow for continuing execution of computer-implemented processes even when a requested element is not available to fulfill the designated task. As another example, generation of separate trained classification models and trained ranking models utilizing iterative training processes applying training data that incorporates the same set of features to different model frameworks having different cost functions provides an improvement in the operation of a computer system in generation of machine learning models, at least for the fact that separate training datasets are not required for training of each model, reducing the storage and processing costs for preparing training datasets. These and other improvements to operation of a computer system will be readily apparent to those of skill in the art.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive a substitution request identifying an anchor element;
generate, by a trained candidate selection model, a set of candidate substitution elements in response to the substitution request, wherein the trained candidate selection model is configured to receive an input set including the anchor element, a feature set, and a set of catalog elements;
rank, by a trained ranking model, the set of candidate substitution elements, wherein the trained ranking model is configured to receive an input set including the anchor element, the feature set, and the set of candidate substitution elements;
select at least one substitution element from the set of candidate substitution elements;
receive feedback data representative of a suitability of the selected at least one substitution element with respect to the anchor element; and
update at least one of the trained candidate selection model or the trained ranking model by applying an iterative training process incorporating at least a portion of the feedback data.

2. The system of claim 1, wherein the processor is configured, prior to receiving the substitution request, to read the set of instructions to:
train the candidate selection model by applying an iterative training process to modify a classification framework based on a first training data set; and
train the ranking model by applying an iterative training process to modify a learning-to-rank framework based on the first training data set.

3. The system of claim 2, wherein the classification framework comprises a feed forward neural network.

4. The system of claim 2, wherein the learning-to-rank framework comprises one of a pairwise ranking or a listwise ranking.

5. The system of claim 4, wherein the learning-to-rank framework comprises one of an XGBoost framework or a LambdaMART framework.

6. The system of claim 1, wherein the at least one substitution element comprises a set of N highest-ranked substitution elements selected from the set of candidate substitution elements.

7. The system of claim 1, wherein the trained candidate selection model is configured to generate an individual relevance score for each element in the set of catalog items.

8. The system of claim 1, wherein the trained ranking model is configured to rank the set of candidate substitution elements by a relative relevance.

9. A computer-implemented method, comprising:
receiving a substitution request identifying an anchor element;
generating, by a trained candidate selection model, a set of candidate substitution elements in response to the substitution request, wherein the trained candidate selection model is configured to receive an input set including the anchor element, a feature set, and a set of catalog elements;
ranking, by a trained ranking model, the set of candidate substitution elements, wherein the trained ranking model is configured to receive an input set including the anchor element, the feature set, and the set of candidate substitution elements;
selecting at least one substitution element from the set of candidate substitution elements;
receiving feedback data representative of a suitability of the selected at least one substitution element with respect to the anchor element; and
updating at least one of the trained candidate selection model or the trained ranking model by applying an iterative training process incorporating at least a portion of the feedback data.

10. The computer-implemented method of claim 9, comprising:
training the candidate selection model by applying an iterative training process to modify a classification framework based on a first training data set; and
training the ranking model by applying an iterative training process to modify a learning-to-rank framework based on the first training data set.

11. The computer-implemented method of claim 10, wherein the classification framework comprises a feed forward neural network.

12. The computer-implemented method of claim 10, wherein the learning-to-rank framework comprises one of a pairwise ranking or a listwise ranking.

13. The computer-implemented method of claim 12, wherein the learning-to-rank framework comprises one of an XGBoost framework or a LambdaMART framework.

14. The computer-implemented method of claim 9, wherein the at least one substitution element comprises a set of N highest-ranked substitution elements selected from the set of candidate substitution elements.

15. The computer-implemented method of claim 9, wherein the trained candidate selection model is configured to generate an individual relevance score for each element in the set of catalog items.

16. The computer-implemented method of claim 9, wherein the trained ranking model is configured to rank the set of candidate substitution elements by a relative relevance.

17. A non-transitory computer readable medium having instructions stored thereon, wherein the instructions, when executed by at least one processor, cause at least one device to perform operations comprising:
training a candidate selection model by applying an iterative training process to modify a classification framework based on a first training data set;
training a ranking model by applying an iterative training process to modify a learning-to-rank framework based on the first training data set;
receiving a substitution request identifying an anchor element;
generating, by the trained candidate selection model, a set of candidate substitution elements in response to the substitution request, wherein the trained candidate selection model is configured to receive an input set including the anchor element, a feature set, and a set of catalog elements;
ranking, by the trained ranking model, the set of candidate substitution elements, wherein the trained ranking model is configured to receive an input set including the anchor element, the feature set, and the set of candidate substitution elements;
selecting at least one substitution element from the set of candidate substitution elements;
receiving feedback data representative of a suitability of the selected at least one substitution element with respect to the anchor element; and
updating at least one of the trained candidate selection model or the trained ranking model by applying an iterative training process incorporating at least a portion of the feedback data.

18. The non-transitory computer readable medium of claim 17, wherein the classification framework comprises a feed forward neural network and the learning-to-rank framework comprises one of a pairwise ranking or a listwise ranking.

19. The non-transitory computer readable medium of claim 18, wherein the learning-to-rank framework comprises one of an XGBoost framework or a LambdaMART framework.

20. The non-transitory computer readable medium of claim 17, wherein the trained candidate selection model is configured to generate an individual relevance score for each element in the set of catalog items and the trained ranking model is configured to rank the set of candidate substitution elements by a relative relevance.
